(19) United States
(12) Patent Application Publication
(10) Pub. No.: US 2022/0274140 A1
(43) Pub. Date: Sep. 1, 2022

(54) CONTAINER TRANSPORT DEVICE

(71) Applicant: HITACHI INDUSTRY & CONTROL SOLUTIONS, LTD., Hitachi-shi, Ibaraki (JP)

(72) Inventors: Tadahiro KATANE, Hitachi-shi, Ibaraki (JP); Hirohisa FUKUDA, Hitachi-shi, Ibaraki (JP); Michio MIMURA, Hitachi-shi, Ibaraki (JP); Kunitaka ASANO, Hitachi-shi, Ibaraki (JP)

(21) Appl. No.: 17/631,122

(22) PCT Filed: Jul. 29, 2020
(86) PCT No.: PCT/JP2020/028974

§ 371 Date: Jan. 28, 2022

(30) Foreign Application Priority Data
Jul. 31, 2019 (JP) 2019-141808

(51) Int. Cl. B07C 5/36; B65G 15/58; B65G 47/84; B65G 17/32; B07C 5/34

(52) U.S. Cl. CPC B07C 5/36; B65G 15/58; B65G 47/848; B65G 17/323; B07C 5/3404; B65G 2201/0235; B07C 5/342

(57) ABSTRACT

A container transport device (100) including: a container holder equipped conveyor belt (1) provided along periphery thereof with plural holders (5) configured to hold containers (101); a container loading mechanism (10) configured to load the containers (101) to the holders (5); an inspection rotor (20) configured to inspect whether the containers (101) have a defect or not while conveying the containers (101) in a circumferential direction; a star wheel (30) configured to transfer the containers (101) from the container holder equipped conveyor belt (1) to the inspection rotor (20); a container sorting mechanism (40) configured to sort the containers (101) based on inspection results. The container holder equipped conveyor belt (1) is arranged to enter an inside of the inspection rotor (20).

### TECHNICAL FIELD

The present invention relates to a container transport device.

### BACKGROUND ART

For example, there is known an inspection device that captures an image of a container (inspection object) filled with injection liquid medicine such as an ampule, a vial, or a prefilled syringe and that inspects an exterior of the container and presence or absence of foreign objects in the container based on the captured image (see Patent Literatures 1 to 3). These Patent Literatures 1 to 3 describe mechanisms that cut out inspection objects, convey the inspection objects with star wheels, and sort each of containers into a non-defective product or a defective product based on results of executed inspection. Moreover, Patent Literature 3 describes a reinspection mechanism (mechanism that returns an uninspected product or a container taken out from an inspection rotor for multiple times of inspection to the inspection rotor and performs inspection again).

### PRIOR ART REFERENCE

### Patent Literature

Patent Literature 1: JP5165009B
Patent Literature 2: JP5468123B
Patent Literature 3: JP5762074B

### SUMMARY OF THE INVENTION

### Problem to be Solved

Such an inspection device is formed of a star wheel that supplies the containers to an inspection machine, a star wheel that conveys the supplied containers to the inspection rotor, a star wheel that takes out the containers from the inspection rotor, and a star wheel for sorting each of the containers into the non-defective product or the defective product.

However, the configurations of Patent Literatures 1 to 3 include many components for conveying the containers and have a problem of an increase in size and cost of the device.

The present invention has been made to solve the aforementioned conventional problem and an object is to reduce the number of components and provide a container transport device that can achieve compact size and low cost.

### Means to Solve the Problem

The present invention is a container transport device including a container holder equipped conveyor belt that is provided with a plurality of holders, configured to hold containers, in a periphery, a container loading mechanism that loads the containers to the holders, an inspection rotor that inspects whether the containers have a defect or not while conveying the containers in a circumferential direction, a transfer rotor that transfers the containers from the container holder equipped conveyor belt to the inspection rotor, and a container sorting mechanism that sorts the containers based on inspection results. Here, the container holder equipped conveyor belt is arranged to enter an inside of the inspection rotor.

### Advantageous Effects of the Invention

The present invention can reduce the number of components and provide a container transport device that can achieve compact size and low cost.

### BRIEF DESCRIPTION OF DRAWINGS

FIG. 1 is an overall configuration diagram illustrating a container transport device in a first embodiment.

FIG. 2 is a development diagram of a container holder equipped conveyor belt as viewed toward an inspection rotor.

FIG. 3 is a cross-sectional diagram illustrating a container sorting device.

FIG. 4 is a plan diagram of a star wheel.

FIG. 5 is a cross-sectional diagram along the A-A line in FIG. 3.

FIG. 6 is a cross-sectional diagram along the B-B line in FIG. 3.

FIG. 7 is a cross-sectional diagram along the C-C line in FIG. 1.

FIG. 8 is an enlarged diagram of holders in a curved conveyance portion of the container holder equipped conveyor belt.

FIG. 9 is a diagram explaining transfer of the containers in the container transport device of the first embodiment.

FIG. 10 is an overall configuration diagram illustrating a container transport device of a second embodiment.

FIG. 11 is a cross-sectional diagram along the D-D line in FIG. 10.

### EMBODIMENTS OF THE INVENTION

Embodiments of the present invention are described below in detail by using the drawings.

### First Embodiment

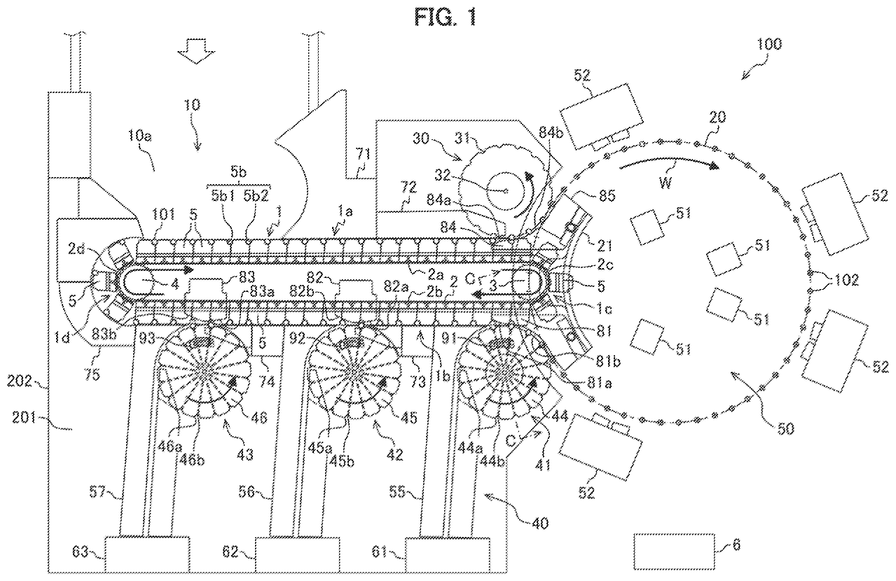

FIG. 1 is an overall configuration diagram illustrating a container transport device in a first embodiment. Note that FIG. 1 is a state where a container transport device 100 is viewed from above. Moreover, in the embodiment, an object to be conveyed by the container transport device 100 is assumed to be, for example, a medical solution product put in a container such as an ampule, a vial, or a syringe and the container in which the medical solution to be inspected is put is simply referred to as an inspection object hereinafter.

As illustrated in FIG. 1, the container transport device 100 includes a container holder equipped conveyor belt 1 (hereinafter, abbreviated as conveyor belt), a container loading mechanism 10, an inspection rotor 20, a star wheel (transfer rotor) 30, and a container sorting mechanism 40.

Moreover, multiple imaging devices 51 are provided inside the inspection rotor 20 in a radial direction. Furthermore, lighting devices 52 are provided at positions facing the imaging devices 51, outside the inspection rotor 20 in the radial direction. Note that the imaging devices 51 and the lighting devices 52 form inspection devices that inspect whether each inspection object 101 has a defect or not.

The conveyor belt 1 is formed of an endless belt portion 2, pulleys 3 and 4, and multiple holders 5.

The belt portion 2 is arranged to elongate in one direction and is laid between the pulleys 3 and 4. The pulleys 3 and 4 are rotatably attached to a conveyance stage 202. Moreover, the belt portion 2 includes linear portions 2a and 2b that are laid between the pulleys 3 and 4 and that are arranged parallel to each other and curved portions 2c and 2d that are arranged along the pulleys 3 and 4. The pulleys 3 and 4 are arranged such that rotation shafts extend in the vertical direction. The belt portion 2 is arranged such that a holder attachment surface faces sideways. Note that drive force of a not-illustrated electric motor is transmitted to one of the pulleys 3 and 4.

Moreover, the holders 5 configured to house the inspection objects 101 (containers) are attached to a surface of the belt portion 2 facing outside. The holders 5 have a substantially quadrilateral shape in a plan view and are configured such that the adjacent holders 5 are in close contact with each other in the linear portions 2a and 2b. Moreover, the holders 5 are not attached to the entire surface of the belt portion 2 but are attached to the belt portion 2 via center portions of bottom surfaces of the holders 5. Furthermore, the holders 5 are in a state where the adjacent holders 5 are separated away from each other in the curved portions 2c and 2d around the pulleys 3 and 4.

Housing portions 5b configured to house the inspection objects 101 are formed on outer surfaces of the holders 5. Each housing portion 5b is formed of a recess portion 5b1 formed in one of the adjacent holders 5 and a recess portion 5b2 formed in the other holder 5. Due to this configuration, the recess portion 5b1 and the recess portion 5b2 are separated away from each other in the conveyance direction in the curved portions 2c and 2d of the belt portion 2.

Moreover, the housing portions 5b of the holders 5 have a depth substantially equal to the diameter of the inspection objects 101. Substantially the entire inspection objects 101 can be thus housed in the housing portions 5b.

The conveyor belt 1 thus includes a linear conveyance portion 1a (first linear conveyance portion) that linearly conveys the inspection objects 101 loaded by the container loading mechanism 10 and a linear conveyance portion 1b (second linear conveyance portion) that linearly conveys the inspection objects subjected to inspection. Moreover, the conveyor belt 1 includes a curved conveyance portion 1c (first curved conveyance portion) connecting one end of the linear conveyance portion 1a and one end of the linear conveyance portion 1b to each other and a curved conveyance portion 1d (second curved conveyance portion) connecting the other end of the linear conveyance portion 1a and the other end of the linear conveyance portion 1b to each other.

The container loading mechanism 10 houses the inspection objects 101 into the housing portions 5b of the holders 5 one by one and is formed of, for example, a supply conveyor 10a. The supply conveyor 10a is, for example, a belt type and is capable of loading many inspection objects 101 at once and loading the inspection objects 101 into multiple housing portions 5b of the conveyor belt 1. Although the container loading mechanism 10 is configured to load the inspection objects 101 into seven housing portions 5b in the embodiment, the number of housing portions 5b is not limited to seven and may be smaller or larger than seven. Moreover, the container loading mechanism 10 may be configured to load the inspection objects 101 to the conveyor belt 1 one by one.

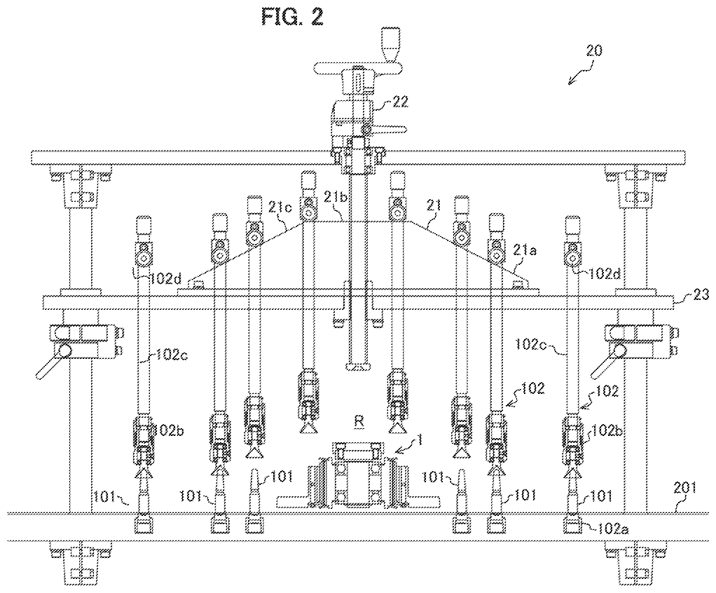

The inspection rotor 20 is configured such that multiple inspection object holding portions 102 (see FIG. 2) configured to hold the inspection objects 101 are provided at even intervals in a peripheral edge portion of a disc or a cylinder. Moreover, the inspection rotor 20 rotates in one direction about the center of the disc or the cylinder and conveys the inspection objects 101, for example, clockwise (in a W direction) in FIG. 1. Note that the inspection rotor 20 is not limited to an annular conveyance device and may have any form as long as a conveyance route has a circulating shape and the inspection object holding portions 102 (see FIG. 2) are provided at even intervals on the conveyance route having the circulating shape and travel at predetermined speed on the conveyance route having the circulating shape.

Moreover, the inspection rotor 20 is provided with inspection devices 50 that inspect whether each inspection object 101 has a defect or not. The inspection devices 50 are formed of the imaging devices (cameras) 51 and the lighting devices 52 and multiple inspection devices 50 are arranged at intervals in a circumferential direction. The imaging devices 51 are provided inside the inspection rotor and the lighting devices 52 are provided outside the inspection rotor 20. Note that the configuration of the inspection devices 50 may be such that arrangement of the imaging devices 51 and the lighting devices 52 is opposite to that in the embodiment. Moreover, the imaging devices 51 and the lighting devices 52 may be provided inside the inspection rotor 20 or outside the inspection rotor 20 and the arrangement can be changed as appropriate.

Furthermore, when the inspection objects 101 (see FIG. 2) held by the inspection object holding portions 102 (see FIG. 2) pass in front of the inspection devices 50, the inspection devices 50 obtain exterior images of the inspection objects 101 by using the imaging devices 51. Foreign objects in the solution, exterior defects of the containers, and the like in the inspection objects 101 are detected by using the obtained exterior images.

Note that, in the embodiment, multiple inspection devices 50 are provided on both sides in the conveyance direction of the inspection objects 101 (provided at four locations in FIG. 1). The inspection devices 50 obtain the external images of the inspection objects 101 in various states, respectively, and detect defects in the inspection objects 101.

The star wheel (transfer rotor) 30 transfers the inspection objects 101 from the conveyor belt 1 to the inspection rotor 20 and is formed of a disc-shaped member having an outer peripheral portion in which housing portions 31 configured to house the inspection objects 101 are formed. Moreover, the star wheel 30 is rotatably attached to the conveyance stage 202 via a shaft 32 extending in the vertical direction.

Note that the star wheel 30 refers to a circular-gear-shaped conveyance device including the housing portions 31 in a peripheral edge portion. Specifically, the star wheel 30 houses the inspection objects 101 in tooth space portions of the circular gear shape. The inspection objects 101 are conveyed with rotation of the star wheel 30 with an outer edge portion of the star wheel 30 serving as a conveyance route.

Moreover, the star wheel 30 is arranged close to both of the inspection rotor 20 and the linear conveyance portion 1a of the conveyor belt 1. Furthermore, in the star wheel 30, the diameter of the star wheel 30 and the number of housing portions 31 are set such that the housing portions 31 and the housing portions 5b of the conveyor belt 1 can face and synchronize with one another and the housing portions 31 and the inspection object holding portions 102 (FIG. 2) of the inspection rotor 20 can face and synchronize with one another.

The container sorting mechanism 40 is formed of a container sorting device 41 including a star wheel 44, a container sorting device 42 including a star wheel 45, and a container sorting device 43 including a star wheel 46. The container sorting device 41 closest to the inspection rotor 20 has a function of receiving the inspection objects 101 from the inspection rotor 20 and delivering the inspection objects 101 to the conveyor belt 1 and a function of sorting the inspection objects 101. The container sorting device 42 has a function of conveying the inspection objects 101 in a direction in which the inspection objects 101 are delivered to the star wheel 45. The container sorting device 43 has a function of conveying the inspection objects 101 in a direction in which the inspection objects 101 are delivered to the star wheel 46.

The star wheel 44 receives the inspection objects 101 from the inspection rotor 20 and keeps holding the inspection objects 101 or delivers the inspection objects 101 to the conveyor belt 1 depending on the inspection results. Moreover, the star wheel 44 is formed of a disc-shaped member having an outer peripheral portion in which housing portions 44a configured to house the inspection objects 101 are formed. Furthermore, the star wheel 44 is rotatably supported on the conveyance stage 202.

Moreover, the star wheel 44 is arranged close to both of the inspection rotor 20 and the linear conveyance portion 1b of the conveyor belt 1. Furthermore, the star wheel 44 is configured to come into contact with (closest to) the conveyor belt 1 at a position where a perpendicular line is drawn from the center of the star wheel 44 to the conveyor belt 1. Specifically, the star wheel 44 is in contact with a linear portion of the conveyor belt 1.

Note that the star wheel 44 refers to a circular-gear-shaped conveyance device including the housing portions 44a in a peripheral edge portion thereof, like the star wheel 30. Specifically, the star wheel 44 houses the inspection objects 101 in tooth space portions of the circular gear shape. The inspection objects 101 are conveyed with rotation of the star wheel 44 with an outer edge portion of the star wheel 44 serving as a conveyance route.

Moreover, a jetting port 44b that jets out air from a wall surface housing the inspection object 101 is formed in each of the housing portions 44a of the star wheel 44. When air is jetted out from the jetting port 44b of the housing portion 44a with the inspection object 101 housed in the housing portion 44a, the inspection object 101 can be sucked toward the housing portion 44a on the side where air is jetted out, by Bernoulli's principle. Jetting out air from the housing portion 44a allows the inspection object 101 to be conveyed with the inspection object 101 sucked to the housing portion 44a of the star wheel 44 as described above.

The star wheel 45 refers to a circular-gear-shaped conveyance device including housing portions 45a in a peripheral edge portion thereof, like the star wheel 44. Specifically, the star wheel 45 houses the inspection objects 101 in tooth space portions of the circular gear shape. The inspection objects 101 are conveyed with rotation of the star wheel 45 with an outer edge portion of the star wheel 45 serving as a conveyance route.

Moreover, a jetting port 45b that jets out air from a wall surface housing the inspection object 101 is formed in each of the housing portions 45a of the star wheel 45. When air is jetted out from the jetting port 45b of the housing portion 45a with the inspection object 101 housed in the housing portion 45a, the inspection object 101 can be sucked toward the housing portion 45a on the side where air is jetted out, by the same principle as that described above. Jetting out air from the housing portion 45a allows the inspection object 101 to be conveyed with the inspection object 101 sucked to the housing portion 45a of the star wheel 45 as described above.

The star wheel 46 refers to a circular-gear-shaped conveyance device including housing portions 46a in a peripheral edge portion thereof, like the star wheels 44 and 45. Specifically, the star wheel 46 houses the inspection objects 101 in tooth space portions of the circular gear shape. The inspection objects 101 are conveyed with rotation of the star wheel 46 with an outer edge portion of the star wheel 46 serving as a conveyance route.

Moreover, a jetting port 46b that jets out air from a wall surface housing the inspection object 101 is formed in each of the housing portions 46a of the star wheel 46. When air is jetted out from the jetting port 46b of the housing portion 46a with the inspection object 101 housed in the housing portion 46a, the inspection object 101 can be sucked toward the housing portion 46a on the side where air is jetted out, by the same principle as that described above. Jetting out air from the housing portion 46a allows the inspection object 101 to be conveyed with the inspection object 101 sucked to the housing portion 46a of the star wheel 46 as described above.

Moreover, the container transport device 100 is provided with a container pusher 81 at a position facing the container sorting device 41. The container pusher 81 includes a guide surface 81b that guides the inspection objects 101 along the star wheel 44 and a return surface 81a that allows the inspection objects 101 to return to the housing portion 5b of the conveyor belt 1.

Note that the container pusher 81 is provided in upper and lower portions of the conveyor belt 1. The container pusher 81 may be provided in one of the upper and lower portions of the conveyor belt 1 as long as it can push the inspection objects 101.

Moreover, the container transport device 100 includes container pushers 82 and 83. The container pusher 82 is provided at a position facing the star wheel 45. The container pusher 83 is provided at a position facing the star wheel 46. The container pusher 82 includes a pushing surface 82a that pushes the inspection objects 101 toward the star wheel 45 and a return surface 82b that allows the pushed inspection objects 101 to return toward the conveyor belt 1. The container pusher 83 includes a pushing surface 83a that pushes each inspection objects 101 toward the star wheel 46 and a return surface 83b that allows the pushed inspection objects 101 to return toward the conveyor belt 1.

Furthermore, the container transport device 100 is provided with a container pusher 84 at a position facing the outer periphery of the star wheel 30. The container pusher 84 includes a pushing surface 84a that pushes the inspection objects 101 toward the star wheel 30 and a guide surface 84b that is formed along the star wheel 30 and that guides the inspection objects 101.

Moreover, the container transport device 100 is provided with an air blower 91 that pushes back the pushed inspection objects 101. Furthermore, the container transport device 100 is provided with air blowers 92 and 93 with the same configuration as the air blower 91.

Furthermore, the container sorting device 41 is provided with a guide member 55 that guides the inspection objects 101 sorted by the star wheel 44 to a non-defective product tray 61. The container sorting device 42 is provided with a guide member 56 that guides the inspection objects 101 sorted by the star wheel 45 to an exterior defective product tray 62. The container sorting device 43 is provided with a guide member 57 that guides the inspection objects 101 sorted by the star wheel 46 to a foreign object defective product tray 63.

Moreover, the container transport device 100 is provided with guide members 71, 72, 73, 74, and 75 that prevent the inspection objects 101 from protruding from the housing portions 5b of the conveyor belt 1 as appropriate. The guide members 71 and 72 are provided in the linear conveyance portion 1a of the conveyor belt 1. The guide members 73 and 74 are provided in the linear conveyance portion 1b of the conveyor belt 1. The guide member 75 is provided in the curved conveyance portion 1d of the conveyor belt 1.

Moreover, the container transport device 100 is arranged in a state where the conveyor belt 1 enters the inside of the inspection rotor 20. In detail, in the conveyor belt 1, the curved conveyance portion 1c enters the inside of the inspection rotor 20 in the radial direction. In other words, the conveyor belt 1 is arranged such that an end portion of the inspection rotor 20 overlaps with the curved conveyance portion 1c in the axial direction (vertical direction).

A control device 6 is formed of a computer including at least a CPU (central processing unit) and a storage device. Moreover, the control device 6 determines whether each inspection object 101 is a non-defective product or a defective product based on the inspection results from the inspection devices 50. Furthermore, the control device 6 determines that the inspection object 101 for which no inspection results from the inspection devices 50 are obtained is an uninspected product.

Note that the defective products are further sorted into smaller categories such as exterior defective product (first defective product), foreign object defective product (first defective product), and the like. Moreover, the control device 6 stores sorting information that indicates into which one of the non-defective product, the defective product, and the uninspected product for each inspection object 101 is sorted, in the storage device (not illustrated), and notifies the sorting information to the container sorting devices 41, 42, and 43.

FIG. 2 is a development diagram of the container holder equipped conveyor belt as viewed toward the inspection rotor. In FIG. 2, the left side of the drawing is the side where the inspection object 101 heads toward the inspection rotor 20 and the right side is the side where the inspection object 101 returns from the inspection rotor 20.

As illustrated in FIG. 2, the inspection rotor 20 is configured such that multiple inspection object holding portions 102 are arranged in the circumferential direction and are moved in the circumferential direction. Each of the inspection object holding portions 102 holds the inspection object 101 by pinching it from above and below and is formed of a reception portion 102a that receives a lower portion of the inspection object 101 and a press-down portion 102b that presses down an upper portion of the inspection object 101 and holds the inspection object 101 together with the reception portion. An upper surface of the reception portion 102a is formed to be flush with the conveyance surface (horizontal surface) 201.

Moreover, the press-down portion 102b includes a connection shaft 102c extending upward in the vertical direction. A roller 102d is provided in an upper portion of the connection shaft 102c. Moreover, the press-down portion 102b can rotate the inspection object 101 while holding the inspection object 101. Foreign objects are detected by imaging the inspection object 101 with the imaging devices 51 while rotating the inspection object 101 and causing the content solution to swirl.

Moreover, the inspection rotor 20 includes a cam 21 that causes the press-down portion 102b of each inspection object holding portion 102 to move up and down. The cam 21 includes a tilted surface 21a that causes the press-down portion 102b to move up, a horizontal surface 21b that maintains the press-down portion 102b at the top, and a tilted surface 21c that causes the press-down portion 102b to move down.

Rotation of the roller 102d along the tilted surface 21a causes the press-down portion 102b to move upward and separate from the upper portion of the inspection object 101. Then, movement of the roller 102d along the horizontal surface 21b causes the press-down portion 102b to move with the press-down portion 102b maintained at the top. Next, the roller 102d moves down along the tilted surface 21c to press down the upper portion of the inspection object 101 and the reception portion 102a and the press-down portion 102b hold the inspection object 101.

Moreover, the inspection rotor 20 is provided with an adjustment member 22 that adjusts the height of the cam 21. Operating the adjustment member 22 causes a stage portion 23 to which the cam 21 is fixed to move up and down.

As described above, the inspection rotor 20 includes the inspection object holding portions 102 configured to hold the inspection objects 101 and moving the press-down portions 102b up and down forms a space R in which no inspection object holding portions 102 are located in the horizontal direction (conveyance direction). The conveyor belt 1 enters the space R formed in the inspection rotor 20. Accordingly, conveyance of the inspection objects 101 housed in the conveyor belt 1 is not hindered.

Moreover, in the inspection rotor 20, the inspection object 101 illustrated in a “passing point” on the left side of the drawing illustrates a state where the inspection object 101 is housed in the star wheel 30 (see FIG. 1) and the inspection object 101 illustrated in “delivery” on the left side of the drawings illustrates a state where the inspection object 101 is transferred from the star wheel 30 to the inspection rotor 20. Furthermore, in the inspection rotor 20, the inspection object 101 illustrated in a “delivery” on the right side of the drawing illustrates a state where the inspection object 101 is transferred from the inspection rotor 20 to the star wheel 44 (see FIG. 1) and the inspection object 101 illustrated in a “passing point” on the right side of the drawing illustrates a state where the inspection object 101 is housed in the star wheel 44 (see FIG. 1).

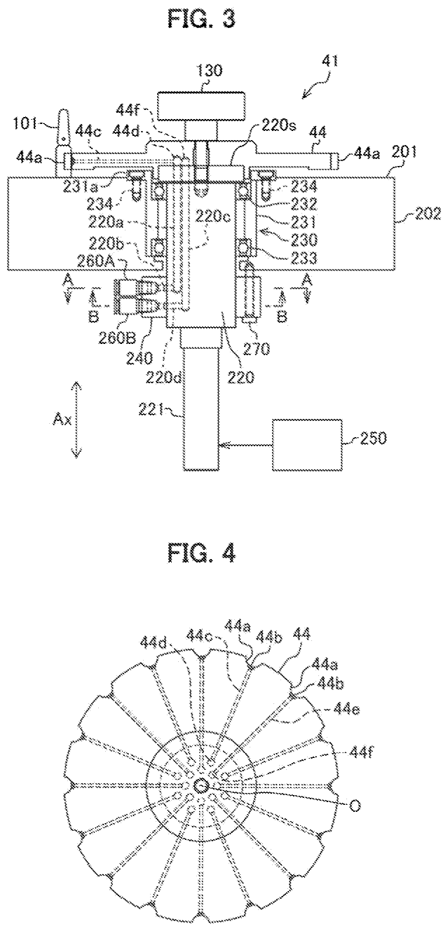

FIG. 3 is a cross-sectional diagram illustrating the container sorting device. Although the container sorting device 41 is described below, the container sorting devices 42 and 43 also have the same configuration as the container sorting device 41 and overlapped description is omitted.

As illustrated in FIG. 3, the container sorting device 41 includes the star wheel 44, a rotation shaft 220, a bearing portion 230, and an air coupling (container suction force generation member) 240. Note that, in the embodiment, the rotation shaft 220, the bearing portion 230, and the air coupling 240 form the container suction force generation mechanism.

The star wheel 44 is arranged on the conveyance surface 201 of the container sorting device 41. Moreover, the star wheel 44 rotates in a state arranged above and away from the conveyance surface 201. The star wheel 44 holds and conveys the inspection objects 101 with the inspection objects 101 sliding on the conveyance surface 201.

The rotation shaft 220 is arranged below the conveyance surface 201 and the star wheel 44 is fixed to an upper surface 220s of the rotation shaft 220. A handle 130 configured to be rotated and operated when the star wheel 44 is attached and detached is provided in an upper portion of a rotation center of the star wheel 44. Although not illustrated, an alignment pin is provided between the star wheel 44 and the rotation shaft 220. This causes the star wheel 44 to rotate together with the rotation shaft 220.

Moreover, the rotation shaft 220 is formed to extend downward in the vertical direction and protrudes from a lower surface of the conveyance stage 202 in which the conveyance surface 201 is formed. Furthermore, a transmission shaft 221 that transmits rotation drive force to the rotation shaft 220 is formed to be coaxial with the rotation shaft 220. The outer diameter of the transmission shaft 221 is formed to be smaller than the outer diameter of the rotation shaft 220. Moreover, the transmission shaft 221 is connected to an electric motor 250 via a not-illustrated pulley.

Air holes 220a and 220c are formed in the rotation shaft 220 to extend in the axial direction Ax of the rotation shaft 220. Moreover, the air holes 220a are located on the outer side of the air holes 220c in the radial direction. Furthermore, the air holes 220a are formed to be shorter than the air holes 220c and lower ends of the air holes 220a are located above lower ends of the air holes 220c. Air holes 44d communicating with the air holes 220a are formed in the star wheel 44. Moreover, air holes 44f communicating with the air holes 220c are formed in the star wheel 44.

The bearing portion 230 includes a base member 231 and bearings (thrust bearings) 232 and 233.

The base member 231 is formed in a substantially-cylindrical shape and an annular flange portion 231a is formed in an upper end portion of the base member 231. The flange portion 231a protrudes upward from the conveyance surface 201. Bolts 234 are inserted in the flange portion 231a and are screwed to the conveyance stage 202 to fasten the base member 231 to the conveyance stage 202. The bearings 232 and 233 are arranged in upper and lower portions of the base member 231.

FIG. 4 is a plan diagram illustrating the star wheel of the container sorting device.

As illustrated in FIG. 4, 16 housing portions 44a are formed in the outer peripheral edge portion of the disc in the star wheel 44. The housing portions 44a are arranged at even intervals (every 22.5 degrees) in a circumferential direction.

In the star wheel 44, air holes 44c and 44e extending in radial directions are formed. One ends of the air holes 44c extend to the housing portions 44a and the other ends extend to the air holes 44d. One ends of the air holes 44e extend to the housing portions 44a and the other ends extend to the air holes 44f. Moreover, the jetting ports 44b that jet out air are formed on the respective wall surfaces of the housing portions 44a to which the air holes 44c and 44e are connected. Openings of the jetting ports 44b are formed to have increased diameter and sucking of the inspection objects 101 is facilitated. Moreover, the other ends (end portions on the inner side in the radial direction) of the air holes 44e are located closer to the rotation center O than the other ends (end portions on the inner side in the radial direction) of the air holes 44c are. Furthermore, the air holes 44c and 44e are alternately formed in the circumferential direction.

The other ends of the air holes 44c and 44e extend to positions overlapping the rotation shaft 220 (see FIG. 3) in the axial direction Ax (vertical direction) (see FIG. 3). Moreover, the air holes 44d and 44f that communicate with the other ends of the air holes 44c and 44e and that extend in the axial direction Ax (vertical direction) for a short distance are formed in the star wheel 44. Lower ends of the air holes 44d and 44f are formed to be open on a bottom surface of the star wheel 44. The air holes 44c, 44d, 44e, and 44f are thus formed to penetrate an interior of the star wheel 44.

Returning to FIG. 3, the air coupling 240 is a unit that supplies air to air holes 220b and 220d of the rotation shaft 220 and is arranged below the conveyance stage 202. Moreover, the air coupling 240 is formed in a substantially annular shape to surround the rotation shaft 220. Furthermore, the air coupling 240 is fixed to the lower surface of the conveyance stage 202 with bolts 270. The thickness of the conveyance stage 202 is formed to be smaller than the length of the rotation shaft 220 in the axial direction.

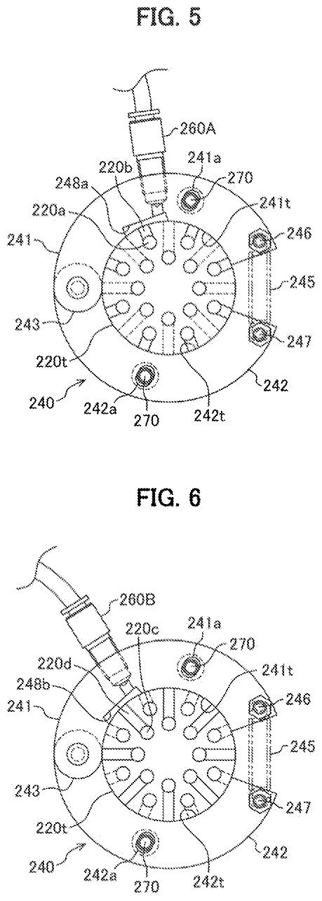

FIG. 5 is a cross-sectional diagram along the A-A line in FIG. 3.

As illustrated in FIG. 5, in the air coupling 240, paired holding portions 241 and 242 formed in arc shapes are turnably connected to each other by a hinge 243. The holding portions 241 and 242 can be thus attached to the rotation shaft 220 to embrace it by opening and closing the holding portions 241 and 242.

Moreover, the holding portions 241 and 242 are each formed to have a smaller length than a semi-circular arc in the circumferential direction. End portions of the holding portions 241 and 242 are thereby spaced away from each other when the rotation shaft 220 is held by and between the holding portions 241 and 242.

Moreover, a coil spring (elastic member) 245 is laid between end portions (other ends) of the holding portions 241 and 242. A lock portion 246 to which one end of the coil spring 245 is locked is formed in the end portion of the holding portion 241 and a lock portion 247 to which the other end of the coil spring 245 is locked is formed in the end portion of the holding portion 242. Elastic force is thereby generated in a direction in which the holding portions 241 and 242 come close to each other, and inner peripheral surfaces 241t and 242t of the holding portions 241 and 242 can be brought into close contact with an outer peripheral surface 220t of the rotation shaft 220.

Moreover, slotted holes 241a and 242a are formed in the holding portions 241 and 242. The bolts 270 are inserted into the slotted holes 241a and 242a and are fastened to the conveyance stage 202. Moreover, forming the slotted holes 241a and 242a in the holding portions 241 and 242 allows the holding portions 241 and 242 to be attached with the holding portions 241 and 242 being in close contact with the outer peripheral surface of the rotation shaft 220.

Moreover, a long groove 248a is formed on the inner peripheral surface 241t of the holding portion 241 to extend in the circumferential direction. The long groove 248a is configured to communicate with the air holes 220b. Moreover, in the holding portion 241, a tube 260A configured to introduce air is provided at a position where the long groove 248a is formed, and the tube 260A and the long groove 248a communicate with each other. Providing the long groove 248a allows air to be continuously supplied to the air hole 220b for a predetermined section of rotation of the rotation shaft 220.

FIG. 6 is a cross-sectional diagram along the B-B line in FIG. 3.

As illustrated in FIG. 6, a long groove 248b is formed on the inner peripheral surface 241t of the holding portion 241 to extend in the circumferential direction. The long groove 248b is located below the aforementioned long groove 248a in the axial direction Ax. The long groove 248b is configured to communicate with the air holes 220d. Moreover, in the holding portion 241, a tube 260B configured to introduce air is provided at a position where the long groove 248b is formed, and the tube 260B and the long groove 248b communicate with each other. Providing the long groove 248b allows air to be continuously supplied to the air hole 220d for a predetermined section of rotation of the rotation shaft 220.

Moreover, the long groove 248b is formed to be shifted from the long groove 248a in the circumferential direction by a distance corresponding to one container. Specifically, the long groove 248a and the long groove 248b are configured such that a half of the long groove 248a overlaps a half of the long groove 248b in the axial direction Ax.

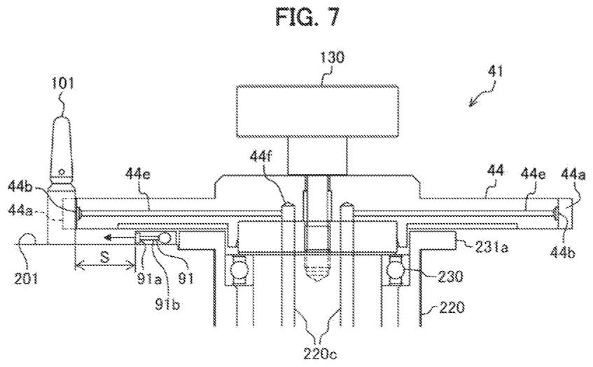

FIG. 7 is a cross-sectional diagram along the C-C line in FIG. 1.

As illustrated in FIG. 7, the air blower 91 is provided on the conveyance surface 201 on the lower surface side (bottom surface side) of the star wheel 44. Note that the air blower 91 is illustrated by solid lines in FIG. 7 and is provided below the star wheel 44. Moreover, the air blowers 92 and 93 are also provided on the lower surface sides of the star wheels 45 and 46 and have the same configuration as the air blower 91. Accordingly, the air blower 91 is described as a representative example, and description of the other air blowers 92 and 93 is omitted.

The air blower 91 has a function of blowing air toward a side surface of a lower portion (peripheral surface of a lower portion) of each inspection object 101 and pushing the inspection object 101 toward the conveyor belt 1. Specifically, the air blower 91 is fixed to the conveyance surface 201 and is provided away from the housing portion 44a housing the inspection object 101 by a distance S, on the inner side of the housing portion 44a in the radial direction. Moreover, the air blower 91 is provided with a blow out port 91a that blows out air toward the inspection object 101. The blow out port 91a is connected to an air supply pipe 91b and is connected to an air supply source (not illustrated). Note that the not-illustrated air supply source is provided separately from the air supply source used to suck the inspection object 101 to the housing portion 44a.

Arranging the air blower 91 away from the inspection object 101 as described above allows the inspection object 101 to be pushed when air is blown out from the blow out port 91a, unlike in the case where air is jetted out from the housing portions 44a.

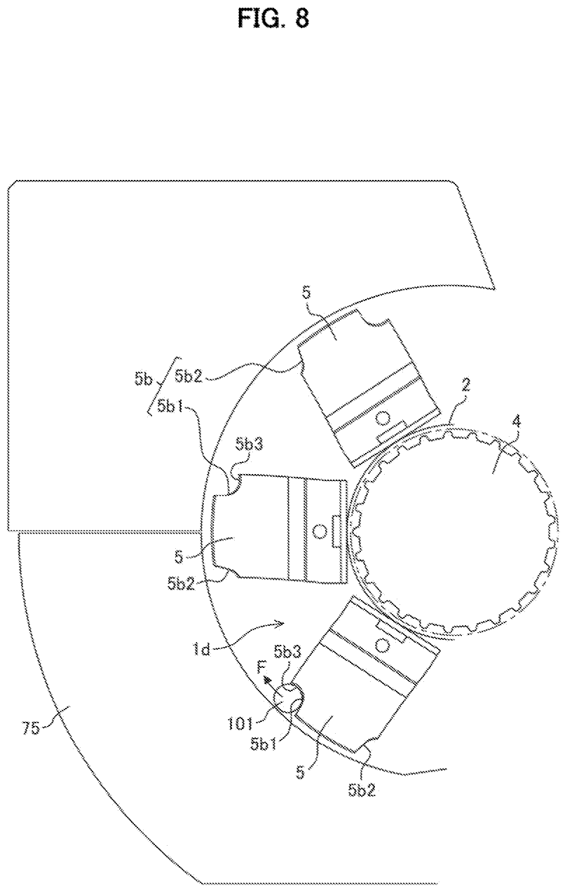

FIG. 8 is an enlarged diagram of the holders in the curved conveyance portion of the container holder equipped conveyor belt. Note that the holders 5 illustrated in FIG. 8 illustrate the holders 5 returning from the container sorting device 43 side to the container loading mechanism 10 side and located in the curved conveyance portion 1d.

As illustrated in FIG. 8, the holders 5 are configured such that separation of the adjacent holders 5 in the curved conveyance portion 1d causes the recess portion 5b1 and the recess portion 5b2 forming the housing portion 5b to separate from each other. The housing portion 5b of the embodiment is not equally divided into the recess portions 5b1 and 5b2, and the recess portion 5b1 located on the upstream side has a shape capable of housing a larger proportion of the inspection object 101. Specifically, a catch portion 5b3 (restraint portion) that catches the inspection object 101 is formed in the recess portion 5b1.

The catch portion 5b3 can thereby suppress moving out of the inspection object 101 from the recess portion 5b1 even if the conveyor belt 1 stops and inertial force F in the conveyance direction acts on the inspection object 101 located in the curved conveyance portion 1d. Accordingly, breakage and damaging of the inspection object 101 can be reduced.

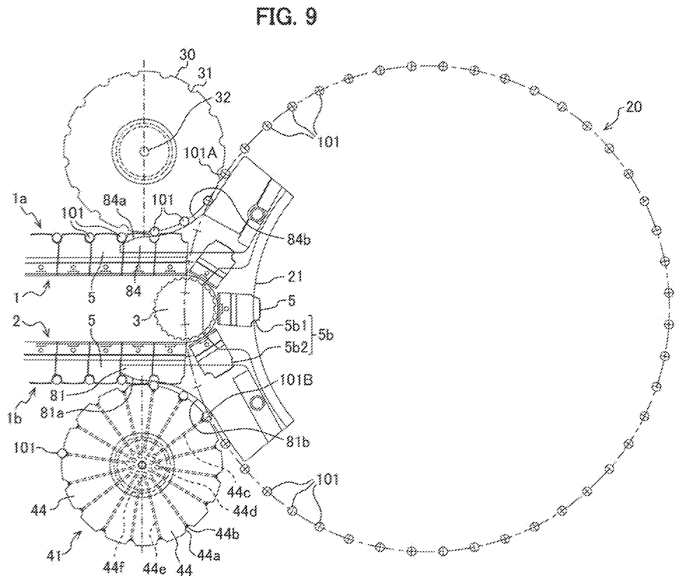

Next, a conveyance operation of the inspection object 101 of the container transport device of the first embodiment is described with reference to FIG. 1 (FIG. 2 to FIG. 9 as necessary). FIG. 9 is a diagram explaining a transfer operation of the inspection objects in the container transport device of the first embodiment.

First, the inspection objects 101 are loaded onto the supply conveyor 10a (see FIG. 1) of the container loading mechanism 10. Many inspection objects 101 are randomly loaded onto the supply conveyor 10a. The supply conveyor 10a moves the inspection objects 101 toward the conveyor belt 1 (see the arrow on the supply conveyor 10a in FIG. 1). Then, the inspection objects 101 are housed in the housing portions 5b, formed in the holders 5 of the conveyor belt 1 facing the supply conveyor 10a, one by one. The inspection objects 101 housed in the housing portions 5b are linearly conveyed in the linear conveyance portion 1a toward the star wheel 30. Note that the guides 71 and 72 are provided between the supply conveyor 10a and the star wheel 30 and the inspection objects 101 thus do not protrude out from the housing portions 5b.

As illustrated in FIG. 9, when each inspection object 101 is conveyed to a position close to the star wheel 30, the container pusher 84 pushes the inspection object 101 toward the star wheel 30 before transfer to the star wheel 30. Specifically, the pushing surface 84a that pushes the inspection object 101 such that the inspection object 101 gradually approaches the star wheel 30 is formed in the container pusher 84. Accordingly, the inspection object 101 gradually approaches the star wheel 30. Moreover, the guide surface 84b that guides the inspection object 101 along a curved surface of the star wheel 30 is formed in the container pusher 84 subsequent to the pushing surface 84a.

The inspection object 101 is housed in the housing portion 31 of the star wheel 30 by being pushed toward the star wheel 30 by the container pusher 84. Note that the inspection object 101 is housed in the housing portion 31 of the star wheel 30 in the linear conveyance portion 1a of the conveyor belt 1. Specifically, the inspection object 101 is housed in the housing portion 31 at a position where a perpendicular line is drawn from the center of the shaft 32 of the star wheel 30 to the conveyor belt 1 (see one dot chain line in FIG. 9) and that overlaps the holder 5.

Then, the inspection object 101 is conveyed toward the inspection rotor 20 by the guide surface 84b and is delivered to the inspection object holding portion 102 (see FIG. 2) of the inspection rotor 20 at the position of the inspection object 101A (see FIG. 9). Next, the inspection devices 50 (see FIG. 2) inspect whether the inspection object 101 held by the inspection object holding portion 102 has a defect or not. Then, the inspection object 101 is conveyed on the circumference and turns back to the star wheel 44 side.

When the inspection object 101 is conveyed to a position close to the star wheel 44, the inspection object 101 is conveyed while being released from the holding by the inspection object holding portion 102 (see FIG. 2). Then, a inspection object 101B is transferred from the inspection rotor 20 to the star wheel 44 at the position illustrated in FIG. 9. Next, the inspection object 101 is guided along the guide surface 81b formed in the container pusher 81 while being housed in the housing portion 44a of the star wheel 44.

When the inspection devices 50 (see FIG. 2) determine that the inspection object 101 is the non-defective product, the inspection object 101 is conveyed while being sucked to the housing portion 44a of the star wheel 44 and is discharged to the non-defective product tray (see FIG. 1) 61. In this case, air is ejected from the corresponding housing portion 44a of the star wheel 44 while the inspection object 101 is guided on the guide surface 81b. Specifically, when the inspection object 101B (see FIG. 9) is the non-defective product, air is supplied from the tube 260A to the long groove 248a of the air coupling 240. Then, the air is introduced into the air hole 220b, passes the air hole 220a to rise in the rotation shaft 220, passes the air holes 44d and 44c of the star wheel 44, and is jetted out from the jetting port 44b in the housing portion 44a of the inspection object 101B. The inspection object 101B is thereby sucked to the housing portion 44a and is conveyed while being housed in the housing portion 44a of the star wheel 44. Moreover, the inspection object 101B conveyed by the star wheel 44 is delivered to the non-defective product tray 61 as the non-defective product. The non-defective product tray 61 conveys the inspection object 101B to the next step.

Meanwhile, when the inspection devices 50 (see FIG. 2) determine that the inspection object 101 is not the non-defective product, the inspection object 101 is conveyed while being housed in the housing portion 5b of the conveyor belt 1. In this case, the inspection object 101 is guided on the guide surface 81b and is then guided by the return surface 81a extending in a direction away from the star wheel 44. Since the air blow out from the jetting port 44b in the housing portion 44a is stopped for the inspection object 101 in this case, the inspection object 101 is not sucked to the housing portion 44a of the star wheel 44. Moreover, air blow out from the air blower 91 (see FIG. 1) provided on the surface below the star wheel 44 pushes the inspection object 101 toward the conveyor belt 1. The inspection object 101 is thereby housed in the housing portion 5b formed in the holders 5 of the conveyor belt 1 and is conveyed to the next container sorting device 42 by the linear conveyance portion 1b.

Moreover, when the inspection object 101 is conveyed to the container sorting device 42, the pushing surface 82a formed in the container pusher 82 pushes the inspection object 101 toward the star wheel 45. Specifically, the inspection object 101 housed in the housing portion 5b is pushed such that substantially a half of the inspection object 101 protrudes from the housing portion 45a (see FIG. 1) (to such a degree that the inspection object 101 comes into contact with the housing portion 45a). In this case, when the inspection object 101 has an exterior defect and is to be conveyed to the exterior defective product tray 62, the inspection object 101 is conveyed on the circumference of the star wheel 45 while being sucked to the housing portion 45a of the star wheel 45. Specifically, this is performed by jetting out air from the jetting port 45b formed in the housing portion 45a of the star wheel 45 and sucking the inspection object 101 to the housing portion 45a. Meanwhile, when the inspection object 101 is to be conveyed by the conveyor belt 1 and sent to the subsequent container sorting device 43, air is blown from the air blower 92 to the inspection object 101 to push the inspection object 101 back to the conveyor belt 1. The return surface 82b that does not hinder the housing of the inspection object 101 in the housing portion 5b when the inspection object 101 is pushed back to the conveyor belt 1 is formed in the container pusher 82.

Moreover, when the inspection object 101 is conveyed to the container sorting device 43, the pushing surface 83a formed in the container pusher 83 pushes the inspection object 101 toward the star wheel 46. Then, as in the container sorting device 42, when the inspection object 101 is to be conveyed to the foreign object defective product tray 63, air is jetted out from the jetting port 46b of the housing portion 46a to suck the inspection object 101 to the housing portion 46a. When the inspection object 101 is the uninspected product, air is blown from the air blower 93 to the inspection object 101 to push back the inspection object 101 to the housing portion 5b of the conveyor belt 1.

The uninspected inspection object 101 is conveyed to the curved conveyance portion 1d and is conveyed to the linear conveyance portion 1a. The inspection object 101 conveyed by the linear conveyance portion 1a is sent to the inspection rotor 20 via the star wheel 30 and the inspection devices 50 inspect whether the inspection object 101 has a defect again.

In the embodiment, the curved conveyance portion 1d of the conveyor belt 1 forms a container return conveyance portion that returns the uninspected inspection object 101 to the inspection rotor 20. Accordingly, there is no need to provide an additional star wheel for returning the inspection object 101 to the inspection rotor 20.

As described above, the container transport device 100 of the first embodiment includes: the conveyor belt 1 provided with multiple holders 5, configured to hold the inspection objects 101, in the periphery; the container loading mechanism 10 that loads the inspection objects 101 to the holders 5; the inspection rotor 20 that inspects whether the inspection objects 101 have a defect or not while conveying the inspection objects 101 in the circumferential direction; the star wheel 30 that transfers the inspection objects 101 from the conveyor belt 1 to the inspection rotor 20; and the container sorting mechanism 40 that sorts the inspection objects 101 based on the inspection results. The conveyor belt 1 is arranged to enter the inside of the inspection rotor 20. According to this configuration, the container transport device 100 can be achieved by three components of the conveyor belt 1, the star wheel 30, and the container sorting mechanism 40 and a compact and low-cost container transport device 100 can be achieved.

Moreover, in the first embodiment, the conveyor belt 1 includes the linear conveyance portion 1a that linearly conveys the inspection objects 101 loaded by the container loading mechanism 10 and the linear conveyance portion 1b that linearly conveys the inspection objects 101 subjected to inspection. Moreover, the conveyor belt 1 includes the curved conveyance portion 1c connecting the one end of the linear conveyance portion 1a and the one end of the linear conveyance portion 1b to each other and the curved conveyance portion 1d connecting the other end of the linear conveyance portion 1a and the other end of the linear conveyance portion 1b to each other. The curved conveyance portion 1c is arranged to enter the inside of the inspection rotor 20 in the radial direction. This allows the container loading mechanism 10 and the star wheel 30 to be arranged in the linear conveyance portion 1a and allows the container sorting mechanism 40 to be provided in the linear conveyance portion 1b. Accordingly, the configurations can be compactly arranged.

Furthermore, in the first embodiment, the holders 5 have the structure (recess portions 5b1 and 5b2) separable into two parts in the conveyance direction of the inspection objects 101. This can suppress the holders 5 from hitting (holders 5 from kicking) the inspection objects 101 when the inspection objects 101 are transferred from the conveyor belt 1 to the star wheel 30. As a result, breakage and damaging of the inspection objects 101 can be reduced.

Moreover, configuring the holders 5 to have the structure separable into two parts can reduce the rotation radius of the rotation of the holders 5 in the curved conveyance portion 1c and it is possible to provide a large space in the inspection rotor 20. Thus, installation of the inspection devices 50 in the inspection rotor 20 is facilitated.

Furthermore, in the first embodiment, the holders 5 have the recess portions 5b1 and 5b2 with such a depth that substantially the entire the inspection object 101 is housed over the diameter thereof. When the inspection objects 101 are housed in the housing portions 5b of the conveyor belt 1 in the container loading mechanism 10 and conveyed, this configuration can prevent or suppress the inspection objects 101 housed in the housing portions 5b from repeatedly colliding with the inspection objects 101 not housed in the housing portions 5b. As a result, breakage and damaging of the inspection objects 101 can be reduced or prevented.

Moreover, in the first embodiment, the container sorting mechanism 40 includes the star wheel 44 that has the housing portions 44a, configured to house the inspection objects 101, in the outer periphery and the container suction force generator that supplies air to the housing portions 44a to generate suction force sucking the inspection objects 101. The star wheel 44 is arranged close to the linear conveyance portion 1b. This allows the side where the inspection object 101 is conveyed while being sucked to the star wheel 44 to be formed in a curved shape and allows the conveyor belt 1 to be formed in a linear shape. Accordingly, the container transport device 100 can be made more compact than the case where both members are formed of star wheels.

Furthermore, in the first embodiment, the container transport device 100 includes the container pushers 84, 81, 82, and 83 that push the inspection objects 101 housed in the holders 5 to the housing portions 31, 44a, 45a, and 46a of the star wheels 30, 44, 45, and 46. This allows the inspection objects 101 to be housed deep inside the holders 5 and can reduce troubles such as the case where the inspection objects 101 collide with each other and break in the container loading mechanism 10.

Moreover, in the first embodiment, the conveyor belt 1 includes the curved conveyance portion 1d (container return conveyance portion) that supplies the inspection objects 101 not sorted by the container sorting mechanism 40 to the inspection rotor 20 again. Addition of a member (star wheel) for returning the inspection objects 101 to the inspection rotor 20 is thereby unnecessary and the container transport device 100 can thus have a compact configuration.

Moreover, in the first embodiment, the catch portions 5b3 that catch the inspection objects 101 and restrain moving out of the inspection objects 101 in the conveyance direction is formed in the recess portions 5b1 of the holders 5 separated into two parts for conveyance of the inspection objects 101 in the curved conveyance portion 1d. This can suppress moving out of the inspection objects 101 from the recess portions 5b1 when the container transport device 100 suddenly stops and the inertial force F in the conveyance direction acts on the inspection objects 101 located in the curved conveyance portion 1d. As a result, breakage and damaging of the inspection objects 101 can be reduced.

### Second Embodiment

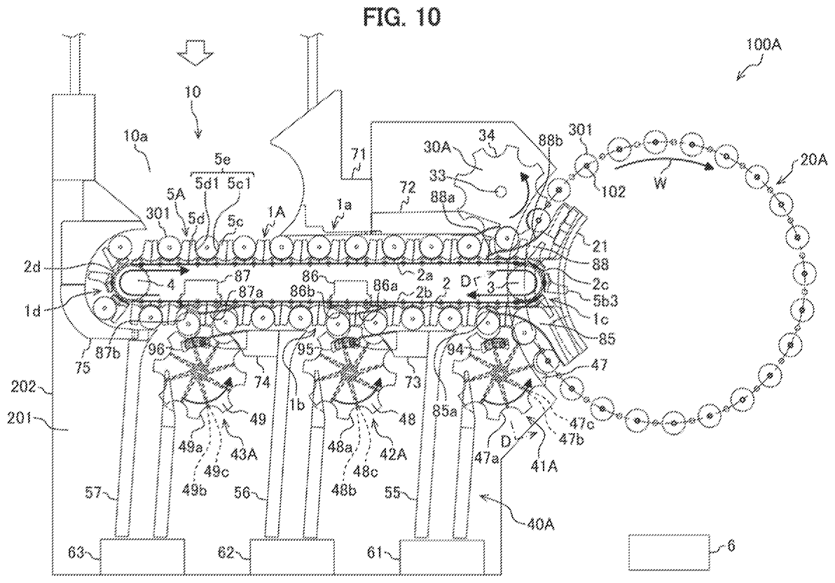

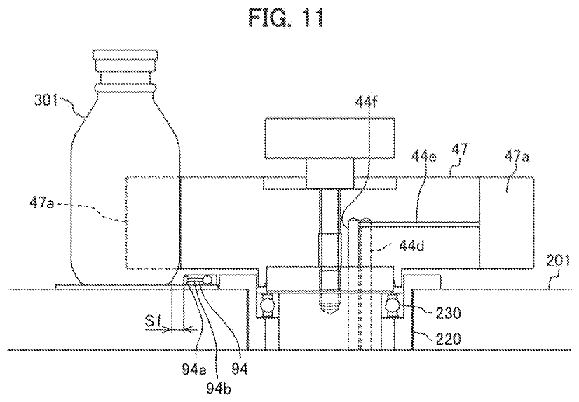

FIG. 10 is an overall configuration diagram illustrating a container transport device of a second embodiment. FIG. 11 is a cross-sectional diagram along the D-D line in FIG. 10. Note that, in the second embodiment, inspection objects 301 (containers) with a larger diameter than the inspection objects 101 in the first embodiment are conveyed.

As illustrated in FIG. 10, the container transport device 100A includes a container holder equipped conveyor belt 1A (hereinafter, abbreviated as conveyor belt), the container loading mechanism 10, an inspection rotor 20A, a star wheel (transfer rotor) 30A, and a container sorting mechanism 40A. Note that the inspection rotor 20A is different from the inspection rotor 20 in the first embodiment only in the shape of the inspection object holding portions 102 configured to hold the inspection objects 301 and has the same basic structure. Accordingly, description thereof is omitted.

In the conveyor belt 1A, holders 5A configured to house the inspection objects 301 (containers) are provided on the outer surface of the belt portion 2. Each of the holders 5A is formed of paired half bodies 5c and 5d. The half bodies 5c and 5d are configured to be separable from each other. Moreover, recess portions 5c1 and 5d1 in each of which a half of the inspection object 301 is housed are formed in the half bodies 5c and 5d. In the embodiment, the recess portions 5c1 and 5d1 form a housing portion 5e.

Moreover, the half bodies 5c and 5d are attached to the belt portion 2 via center portions. In the curved portions 2c and 2d, the adjacent half bodies 5c and 5d are thus separated from each other and are in an open state.

The star wheel 30A (transfer rotor) has the same basic configuration as the star wheel 30 in the first embodiment and is different only in the size and the number of housing portions 34.

The container sorting mechanism 40A is formed of a container sorting device 41A including a star wheel 47, a container sorting device 42A including a star wheel 48, and a container sorting device 43A including a star wheel 49. The container sorting device 41A closest to the inspection rotor 20A has a function of receiving the inspection objects 301 from the inspection rotor 20A and delivering the inspection objects 301 to the conveyor belt 1A and a function of sorting the inspection objects 301. The container sorting device 42A has a function of sorting the inspection objects 301 by conveying the inspection objects 301 in a direction in which the inspection objects 301 are delivered to the star wheel 48. The container sorting device 43A has a function of sorting the inspection objects 301 by conveying the inspection objects 301 in a direction in which the inspection objects 301 are delivered to the star wheel 49.

The star wheel 47 receives the inspection objects 301 from the inspection rotor 20A and keeps holding the inspection objects 301 or delivers the inspection objects 301 to the conveyor belt 1A depending on the inspection results. Moreover, the star wheel 47 is formed of a disc-shaped member having an outer peripheral portion in which housing portions 47a configured to house the inspection objects 301 are formed. Furthermore, the star wheel 47 is rotatably supported on the conveyance stage 202.

Moreover, jetting ports 47b and 47c that jet out air (gas) from wall surfaces housing the inspection objects 301 are formed in the housing portions 47a of the star wheel 47. Two jetting ports 47b and 47c are formed for one housing portion 47a. The air holes 44c, 44d, 220a, and 220b (see FIGS. 3 and 4) are connected to the jetting ports 47b. The air holes 44e, 44f, 220c, and 220d (see FIGS. 3 and 4) are connected to the jetting ports 47c.

Moreover, since the long groove 248a (see FIG. 5) and the long groove 248b (see FIG. 6) are arranged one on top of the other for one container, air can be supplied for a long period. Thus, in the case of the inspection object 301 with a large container diameter as in the second embodiment, air can be supplied for a long period until the branching of the inspection object 301 is completed. Moreover, two jetting ports 47b and 47c are provided for one housing portion 47a and the long grooves 248a and 248b are configured to partially overlap each other in the axial direction. Air can be thereby simultaneously jetted out from both of the jetting ports 47b and 47c. Accordingly, even if the inspection object is the large inspection object 301, the inspection object 301 can be stably drawn toward the housing portion 47a.

Note that housing portions 48a configured to house the inspection objects 301 are formed in an outer peripheral portion of the star wheel 48. Moreover, jetting ports 48b and 48c configured to blow out air are formed in the housing portions 48a. Housing portions 49a configured to house the inspection objects 301 are formed in an outer peripheral portion of the star wheel 49. Jetting ports 49b and 49c configured to blow out air are formed in the housing portions 49a. Furthermore, configurations for blowing out air from the jetting ports 48b, 48c, 49b, and 49c are the same as the configuration in the star wheel 47.

Moreover, the conveyance surface 201 is provided with a container pusher 88 that pushes the inspection objects 301 toward the star wheel 30A. The container pusher 88 includes a pushing surface 88a that pushes the inspection objects 301 from the conveyor belt 1A toward the star wheel 30A and a guide surface 88b that guides the inspection objects 301 along the outer periphery of the star wheel 30A.

Furthermore, the container sorting device 41A is provided with a container pusher 85 that pushes the inspection objects 301 from the inspection rotor 20A to the housing portions 47a of the star wheel 47. A guide surface 85a that guides the inspection objects 301 toward the conveyor belt 1A is formed in the container pusher 85.

Moreover, the container sorting device 42A is provided with a container pusher 86 that pushes the inspection objects 301 to the housing portions 48a of the star wheel 48. The container pusher 86 includes a pushing surface 86a that pushes the inspection objects 301 toward the housing portions 48a of the star wheel 48 and a return surface 86b that causes the inspection objects 301 to return to the conveyor belt 1A.

Furthermore, the container sorting device 43A is provided with a container pusher 87 that pushes the inspection objects 301 to the housing portions 49a of the star wheel 49. The container pusher 87 includes a pushing surface 87a that pushes the inspection objects 301 toward the housing portions 49a of the star wheel 49 and a return surface 87b that causes the inspection objects 301 to return to the conveyor belt 1A.

As illustrated in FIG. 11, an air blower 94 has a function of blowing air toward a side surface of a lower portion (peripheral surface of a lower portion) of the inspection object 301 and pushing the inspection object 301 toward the conveyor belt 1A. Specifically, the air blower 94 is fixed to the conveyance surface 201 and is provided away from the housing portion 47a housing the inspection object 301 by a distance S1, on the inner side of the housing portion 47a in the radial direction. Moreover, the air blower 94 is provided with a blow out port 94a that blows out air toward the inspection object 301. The blow out port 94a is connected to an air supply pipe 94b and is connected to an air supply source (not illustrated).

Arranging the air blower 94 close to the inspection object 301 as described above allows the large inspection object 301 to be pushed out when air is blown out from the blow out port 94a.

As described above, effects similar to those in the first embodiment can be also obtained in the container transport device 100A of the second embodiment.

The present invention is not limited to the aforementioned embodiments and includes various modified examples. For example, although the container transport devices 100 and 100A including the container sorting devices 42 and 42A configured to sort the exterior defective product and the container sorting device 43 and 43A configured to sort the foreign object defective product are described as examples in the aforementioned embodiments, the container transport device may be configured to include one container sorting device for defective products.

Moreover, although substantially racetrack shaped (oval shaped) conveyor belts are described as examples of the container holder equipped conveyor belts 1 and 1A, the belt conveyor may have another shape such as a triangular shape by increasing the number of pulleys.

Furthermore, although the structures in which the holders 5 and 5A are separable into two parts are described as examples of the structure of the holders in the first and second embodiments, holders with a structure that does not separate into two parts may be used.

Moreover, although the mechanism that sucks the inspection objects 101 by jetting out air from the jetting ports 44b, 45b, and 46b of the housing portions 44a, 45a, and 46a is described as an example of the mechanism for sucking the inspection objects 101 to the housing portions 44a, 45a, and 46a in the aforementioned embodiments, a configuration that sucks the inspection objects 101 to the housing portions 44a, 45a, and 46a by sucking air from the jetting ports 44b, 45b, and 46b and generating negative pressure may be used.

### LIST OF REFERENCE SIGNS

1, 1A container holder equipped conveyor belt
1a linear conveyance portion (first linear conveyance portion)
1b linear conveyance portion (second linear conveyance portion)
1c curved conveyance portion (first curved conveyance portion)
1d curved conveyance portion (second curved conveyance portion, container return conveyance portion)
2 belt portion
3, 4 pulley
5, 5A holder
5b, 5e housing portion
5b1, 5b2 recess portion
5b3 catch portion (restraint portion)
5c, 5d half body
5c1, 5d1 recess portion
6 control device
10 container loading mechanism
10a supply conveyor
20 inspection rotor
30, 33 star wheel (transfer rotor)
44, 45, 46, 47, 48, 49 star wheel
31, 34 housing portion
40, 40A container sorting mechanism
41, 41A, 42, 42A, 43, 43A container sorting device
44a, 45a, 46a, 47a, 48a, 49a housing portion
44b, 45b, 46b, 47b, 47c, 48b, 48c, 49b, 49c jetting port
44c, 44d, 44e, 44f air hole
50 inspection device
51 imaging device
52 lighting device
81, 82, 83, 85, 86, 87 container pusher
91, 92, 93, 94, 95, 96 air blower
100, 100A container transport device
101, 301 inspection object (container)
102 inspection object holding portion
201 conveyance surface
202 conveyance stage
220 rotation shaft (container suction force generation mechanism)
220a to 220d air hole (container suction force generation mechanism)
230 bearing portion (container suction force generation mechanism)
240 air coupling (container suction force generation mechanism)
248a, 248b long groove

1. A container transport device comprising:
a container holder equipped conveyor belt provided along a periphery thereof with plural holders configured to hold containers;
a container loading mechanism configured to load the containers to the holders respectively;
an inspection rotor configured to inspect whether the containers have a defect or not while conveying the containers in a circumferential direction;
a transfer rotor configured to transfer the containers from the container holder equipped conveyor belt to the inspection rotor; and
a container sorting mechanism configured to sort the containers based on inspection results, wherein
the container holder equipped conveyor belt is arranged to enter an inside of the inspection rotor.

2. The container transport device as claimed in claim 1, wherein
the container holder equipped conveyor belt includes:
a first linear conveyance portion configured to linearly convey the containers loaded by the container loading mechanism;
a second linear conveyance portion configured to linearly convey the containers having undergone inspection;
a first curved conveyance portion connecting one end of the first linear conveyance portion and one end of the second linear conveyance portion to each other; and
a second curved conveyance portion connecting another end of the first linear conveyance portion and another end of the second linear conveyance portion to each other, and
the first curved conveyance portion is arranged to enter an inside of the inspection rotor in a radial direction.

3. The container transport device as claimed in claim 2, wherein the holders have a structure separable into two parts in a conveyance direction of the containers.

4. The container transport device as claimed in claim 1, wherein the holders have recess portions having a depth configured to house substantially entirely the containers over a diameter thereof respectively.

5. The container transport device as claimed in claim 2, wherein
the container sorting mechanism includes: a star wheel including along an outer periphery thereof housing portions configured to house the containers; and a container suction force generation mechanism configured to supply gas to the housing portions to generate suction force to suck the containers, and
the star wheel is arranged to be in contact with the second linear conveyance portion.

6. The container transport device as claimed in claim 5, further comprising a container pusher configured to push out the containers housed in the holders and push the containers into the housing portions of the star wheel.

7. The container transport device as claimed in claim 1, wherein the container holder equipped conveyor belt includes a container return conveyance portion configured to supply the containers not sorted by the container sorting mechanism to the inspection rotor again.

8. The container transport device as claimed in claim 3, wherein restraint portions are formed in recess portions of the holders separated into two parts respectively for conveyance of the containers in the second curved conveyance portion,
wherein the restraint portions are configured to catch the containers and restrain the containers from moving out in a conveyance direction respectively when the holders are separated into two parts.
